(19) United States
(12) Patent Application Publication
(10) Pub. No.: US 2013/0257684 A1
(43) Pub. Date: Oct. 3, 2013

(54) SCREEN IMAGE TRANSFER DEVICE AND SCREEN IMAGE TRANSFER SYSTEM

(71) Applicant: KABUSHIKI KAISHA TOSHIBA, Tokyo (JP)

(72) Inventors: Mika MINEMATSU, Tokyo (JP); Masataka GOTO, Kanagawa (JP)

(73) Assignee: Kabushiki Kaisha Toshiba, Tokyo (JP)

(21) Appl. No.: 13/776,619

(22) Filed: Feb. 25, 2013

(30) Foreign Application Priority Data
Mar. 29, 2012 (JP) 2012-078367

(51) Int. Cl. G09G 5/00

(52) U.S. Cl. CPC G09G 5/00; H04L 67/10
USPC 345/1.3; 709/204

(57) ABSTRACT

A screen image transfer device includes a screen image data storage module that stores screen image data of a screen image displayed on a display device, a connection allotment module that allots/assigns a different connection to each of multiple screen regions of the display device, and a communications module that transmits the stored screen image data to the screen regions of the display device over the different connections assigned by the connection allotment module.

### CROSS-REFERENCE TO RELATED APPLICATION

This application is based upon and claims the benefit of priority from Japanese Patent Application No. 2012-078367, filed Mar. 29, 2012; the entire contents of which are incorporated herein by reference.

### FIELD

Embodiments described herein relate to a screen image transfer device and a screen image transfer system.

### BACKGROUND

A conventional screen image transfer system includes a simple input/output interface and a display device arranged for a user, and executes complicated arithmetic and logic operations in a screen image transfer device located at a site remote from the user. For example, according to operation information from the display device, the screen image transfer device generates screen image data, and the generated screen image data is then sequentially transmitted from the screen image transfer device to the display device to display the screen image data.

However, because the screen image data is transmitted sequentially from the screen image transfer device to the display device, a delay takes place in transmission of the screen image data and drift takes place in the display timing of the screen image data at the display device of the user. That is, changes in screen image data are not instantaneously displayed on the display device of the user.

To shorten the delay in transmission of the screen image information, there is an existing system that carries out parallel processing for communication by plural network interface cards (NICs) as the input/output interface of the screen image transfer device. In such a system, plural network interface cards (NICs) are adopted, and communication processing is carried out in parallel. However, when drift in the display timing in the adjacent screen regions of the display device takes place for the screen image information generated simultaneously, the user is still prone to see the drift in the screen image display, causing user discomfort. This is undesirable.

### DESCRIPTION OF THE DRAWINGS

FIG. 1 is a diagram illustrating components of a screen image transfer system according to a first embodiment.

FIG. 2 is a diagram illustrating an example connection allotment in the screen image transfer device according to the first embodiment.

FIG. 3 is a diagram illustrating an example of the screen image displayed on a display device according to the first embodiment.

FIG. 4 is a schematic flow chart illustrating an initial screen image transfer processing according to the first embodiment.

FIG. 5 is a schematic diagram illustrating a screen image transfer treatment (process) according to the first embodiment.

FIG. 6 is a diagram illustrating components of a screen image transfer system according to a second embodiment.

FIG. 7 is a diagram illustrating an example connection allotment in the screen image transfer device according to the second embodiment.

FIG. 8 is a diagram illustrating an example of an updated screen image in the screen image transfer device according to the second embodiment.

FIG. 9 is a schematic flow chart illustrating an initial screen image transfer processing according to the second embodiment.

FIG. 10 is a schematic diagram illustrating the screen image transfer processing according to the second embodiment.

### DETAILED DESCRIPTION

The present disclosure is provided to solve the aforementioned problems of the related art by providing a screen image transfer device and a screen image transfer system that reduce the drift in the display timing of the display device to insignificant levels.

In general, embodiments of a screen image transfer device that transmits screen image information to a display device including plural screen image regions connected via a network, and which has a connection allotment module that determines the allotment of different connections to the plural screen regions of the display device and a communication module that transmits the screen image information corresponding to the various screen regions of the display device via the connections assigned by the connection allotment module are described.

Also, an embodiment of the present disclosure provides a screen image transfer system having a screen image transfer device that generates the screen image information and a display device including plural screen regions connected via the network to the screen image transfer device and displaying the screen image information. The screen image transfer device has a connection allotment module that determines the allotment of different connections to the plural screen regions of the display device and a communication module that transmits the screen image information corresponding to the various screen regions of the display device via the connections assigned by the connection allotment module.

### First Embodiment

In the following, the screen image transfer system according to an embodiment will be explained with reference to figures.

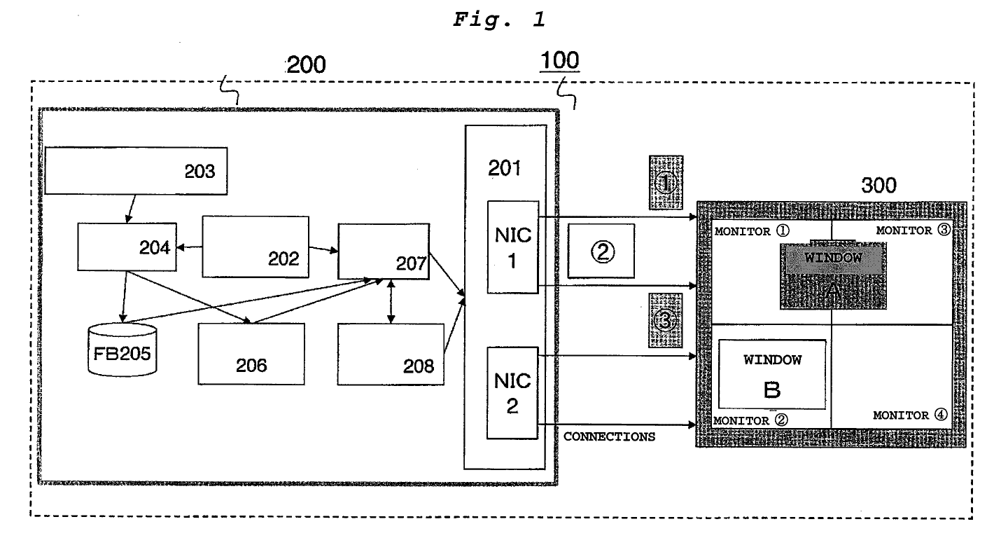

FIG. 1 is a schematic block diagram illustrating an example of the constitution of a screen image transfer system 100 according to a first embodiment. In the system according to the first embodiment, as shown in FIG. 1, a screen image transfer device 200 and a display device 300 are connected with each other via network communications. Here, any type of network may be adopted, such as a LAN (Local Area Network) or the Internet. In the embodiment shown in FIG. 1, only one display device 300 is shown. However, the present disclosure is not limited to this scheme, and there may be any number of the display devices 300 in communication with the screen image transfer device 200. Here, the system may be arranged such that communication is carried out between the screen image transfer device 200 and each of the two or more display devices 300.

In the example shown in FIG. 1, the screen image transfer device 200 has a communication interface via a communication module 201 with two NICs. The display device 300 includes four monitors (monitor 1, monitor 2, monitor 3, and monitor 4). However, the number of the NICs of the communication module 201 is not limited to two, and the number of the monitors in the display device 300 is not limited to four. The number of monitors and NICs may be greater or lesser than the stated example.

In the screen image transfer system 100, the screen image transfer device 200 receives a screen image update request message from the display device 300 and then transmits the screen image information corresponding to this screen image update request message to the display device 300. Here, the screen image information refers to the image information to be displayed on the screen of the display device 300. In the initial stage of the screen image transfer from the screen image transfer device 200 to the display device 300, the screen image information for an entire screen image is transmitted, and then subsequently only the screen image information of the screen region where an update to the screen image takes place is transmitted.

In this case, the screen image transfer device 200 may transmit the screen image information just when receiving a screen image update request message or it may receive an update request message once at the start of the screen image transmission and then automatically transmit the screen image information afterwards.

As shown in FIG. 1, the screen image transfer device 200 according to this embodiment has a communication module 201, a layout storage module 202, an application 203, a depicting module 204, a screen image information storage module (frame buffer) 205 (FB205), an update detecting module 206, a screen image transfer module 207, and a connection allotment module 208.

The communication module 201 receives the screen image update request message from the display device 300 and then transmits the screen image information corresponding to this screen image update request message to the display device 300.

The layout storage module 202 stores the display regions displayed on the display device 300. The display regions are stored by coordinate information or other position information. For example, for a screen image having 1024×768 pixels, the coordinate information may refer to the information represented in a coordinate system with the upper-left corner of the screen represented by (0, 0) and the lower-right corner of the screen represented by (1023, 767). There is no specific restriction on the storage method of the display region coordinate information, and any method may be adopted as long as the method for arranging the screen image information is understood.

In the embodiment of a display device 300 including four monitors shown in FIG. 1, the display region refers to the information including a display region 1 for monitor 1 having a width of 1400 pixels and a height of 1050 pixels from (0, 0) on the screen, a display region 2 for monitor 2 having a width of 1400 pixels and a height of 1050 pixels from (0, 1050) on the screen, a display region 3 for monitor 3 having a width of 1400 pixels and a height of 1050 pixels from (1400, 0) on the screen, and a display region 4 for monitor 4 having a width of 1400 pixels and a height of 1050 pixels from (1400, 1050) on the screen.

The application 203 is a program that provides various types of processings for operation on the screen image transfer device 200.

The frame buffer 205 is a screen image information storage module that stores the screen image information of the screen image to be displayed on the display device 300. Here, the frame buffer 205 may be made of any of the conventionally adopted storage media, such as a Random Access Memory (RAM), a Hard Disk Device (HDD), an optical disk, a memory card, etc.

The depicting module 204 receives a depicting command from the application 203 and, according to the received depicting command, carries out various types of screen image processings. The depicting module 204 then stores the processed screen image information in frame buffer 205. The depicting module 204 then also stores the update region specified in the depicting command by coordinate information, or the like, in the update detecting module 206. There is no specific restriction on the storage method of for the update region, and any method that allows distinction of the specified update region of the screen image can be adopted.

For example, for a rectangular update region with a width of 10 pixels and a height of 10 pixels from (0, 0) and a second update rectangular region with a width of 200 pixels and of a height of 5 pixels from (30, 30), the update region may be stored as a list of rectangular coordinate information.

The update detecting module 206 notifies the screen image transfer module 207 of the specified update region. Here, the update detecting module 206 may also include a differential extracting processing.

In differential extracting processing, the screen image information of frame buffer 205 corresponding to the update region is compared with a backup screen image previously transmitted to the display device 300, the differential region containing actual image changes is extracted, and only this differential region is used as the update region. Also, the backup screen image is updated.

The screen image transfer module 207 compares the display regions and the update region, then reads the screen image information for overlapped portions of the display and update regions from frame buffer 205, generates an updated screen image, checks the connection assigned by the connection allotment module 208 and provides the communication module 201 with the information of the updated screen image. The region corresponding to the updated screen image is then deleted from update detecting module 206.

For example, in the example shown in FIG. 1, when the entirety of window A (1024×768 pixels) is updated, on the left hand portion of window A, an updated screen image with a width of 500 pixels and a height of 768 pixels is generated for monitor 1, and on the right hand portion of the window an updated screen image with width of 524 pixels and height of 768 pixels is generated for monitor 3.

The screen image transfer module 207 may also contain an image format conversion processing capability and a compression processing capability. With the image format conversion processing, the pixel format or the like of the updated screen image is converted. With the compression processing, the updated screen image is compressed.

The connection allotment module 208 allots the connections using different transmission NICs for adjacent screen regions. As shown in FIG. 1, a separate connection is arranged for each of the four monitors. However, the same effect can be realized by using a separate connection for each of four screen regions obtained by dividing a single monitor in to four portions.

Now, the screen image transfer processing by screen image transfer device 200 related to the first embodiment will be explained.

First, with reference to FIG. 4 a brief account will be given of the initial screen image transfer processing.

The layout storage module 202 acquires a display region from the screen image transmission start request message received from the display device 300 and stores it. The screen image transmission start request message includes the dimensions of the regions on the screen image to be updated. For the example depicted in FIG. 1, when the display device includes four monitors, the information of the following regions is included: the region on monitor 1 having a width of 1400 pixels and a height of 1050 pixels from (0, 0) on the screen((0,0) is the upper left corner of the display device 300), the region on monitor 2 having a width of 1400 pixels and a height of 1050 pixels from (0, 1050) on the screen, the region on monitor 3 having a width of 1400 pixels and a height of 1050 pixels from (1400, 0) on the screen, and the region on monitor 4 having a width of 1400 pixels and a height of 1050 pixels from (1400, 1050) on the screen.

In the case when a single monitor is divided in to four screen regions, each corresponding to a separate connection, the dimensions of the rectangular region contained in the screen image transmission start request message would be stored as the region on the screen of the monitor with a width of 2800 pixels and a height of 2100 pixels from (0, 0) divided in to four portions as the display regions.

Connection allotment module 208 then determines the transmission NIC for each display region. For example, it may determine that the updated screen image corresponding to the monitors 1 and 4 is to be transmitted from a NIC 1, and the updated screen image corresponding to the monitors 2 and 3 is to be transmitted from a NIC 2.

Then, communication module 201 sets up the connection with display device 300 using the transmission NIC assigned by the connection allotment module 208. For example, four connections may be arranged between the screen image transfer device 200 and the display device 300 as follows: a connection 1 with the NIC 1 as the transmission NIC for transmission to monitor 1, a connection 2 with the NIC 2 as the transmission NIC for transmission to monitor 2, connection 3 with a NIC 3 as the transmission NIC for transmission to monitor 3, and a connection 4 with a NIC 4 as the transmission NIC for transmission to monitor 4.

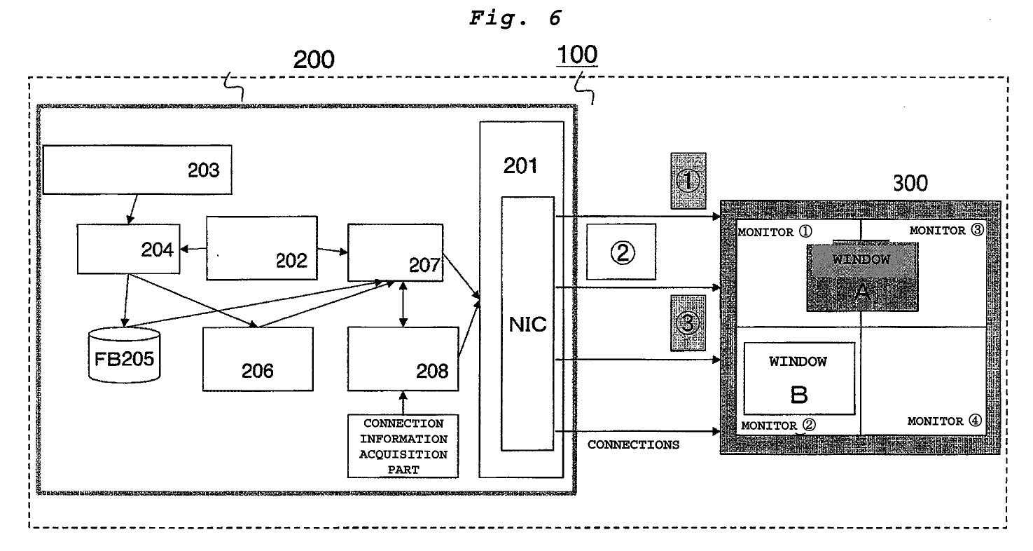

In the following, a brief account of the depicting processing and the screen image transfer processing will be explained with reference to FIG. 5.

First, as a depicting command is issued for screen image display from application 203, depicting module 204 of the screen image transfer device 200 depicts the screen image in the frame buffer 205.

Then, for example, upon a trigger turned on at a prescribed time by a timer, the screen image transfer processing is started.

First, the update detecting module 206 detects the update region, and the screen image transfer module 207 generates an updated screen image.

Then, the screen image transfer module 207 checks the connection allotment module 208 for the connection corresponding to the display region where the updated screen image is located, and the updated screen image is transferred to the communication module 201 for transfer to display device 300.

For example, for the updated screen image with respect to the monitor 1 in the region with a width of 1400 pixels and a height of 1050 pixels from (0, 0) on the screen image, the screen image transfer module 207 checks which connection is adopted for transmission by the connection allotment module 208, and then communication module 201 transmits the updated screen image by the connection assigned by the connection allotment module 208 (e.g., connection 1). Then, for the updated screen image with respect to the monitor 3 adjacent to the monitor 1, the screen image transfer module 207 checks which connection is adopted for transmission by the connection allotment module 208, and then communication module 201 transmits the updated screen image by the connection assigned by the connection allotment module 208 (e.g., connection 3).

Similarly, for the updated screen image with respect to the monitor 2, the screen image transfer module 207 checks which connection is adopted for transmission by the connection allotment module 208, and then communication module 201 transmits the updated screen image by the connection assigned by the connection allotment module 208 (e.g., connection 2). Then, for the updated screen image with respect to monitor 4 adjacent to the monitor 2, the screen image transfer module 207 checks which connection is adopted for transmission by the connection allotment module 208, and then communication module 201 transmits the updated screen image by the connection assigned by the connection allotment module 208 (e.g., connection 4).

In this way, for the screen image transfer device 200 in the first embodiment, the updated screen images of the adjacent screen regions that are prone to updating simultaneously are transmitted using different NICs as the transmission NICs, so that the drift in the arrival times to the display device 300 can be decreased, and the drift in the display timing can be made insignificant to the user.

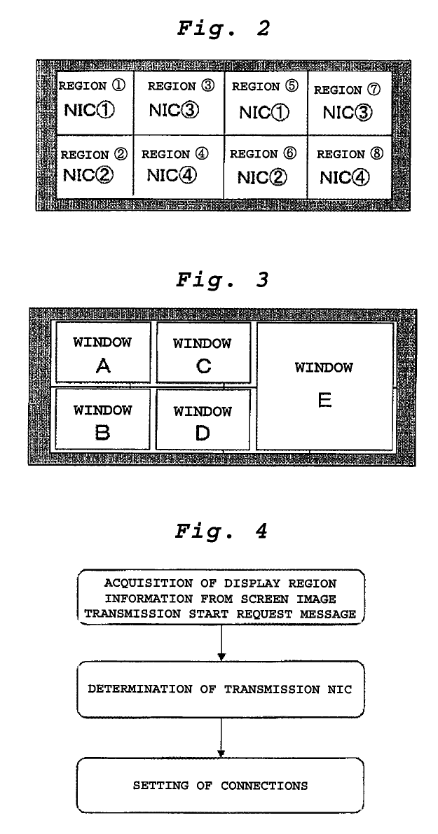

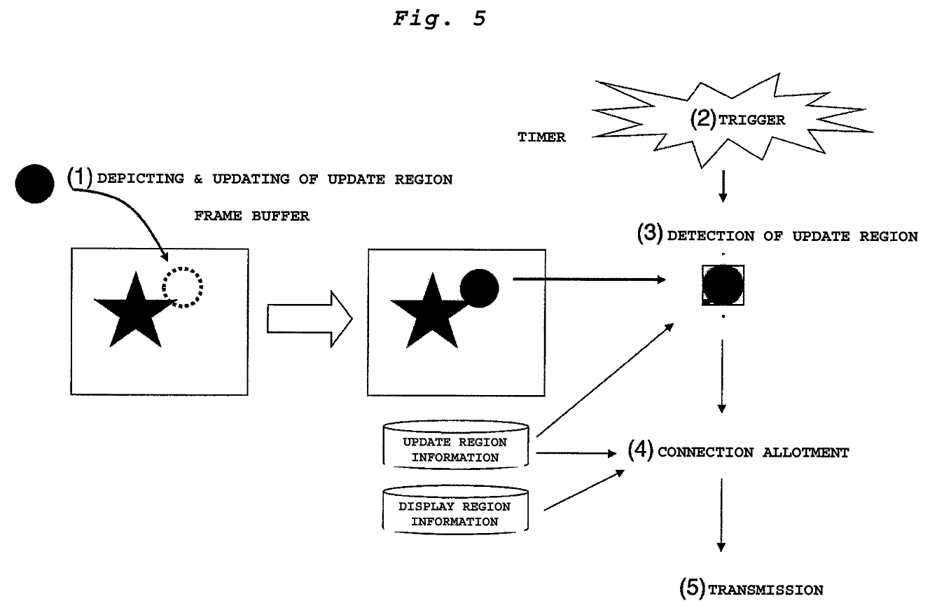

FIG. 2 is a diagram illustrating an embodiment of allotment of connections in a display device 300 having eight screen regions and including a screen image transfer device 200 having four NICs. FIG. 3 is a diagram illustrating an example of a screen image displayed on the display device 300 shown in FIG. 2. In the example shown in FIG. 3, five applications 203 corresponding to windows A through E, respectively, are depicted. There is a high probability that updating takes place simultaneously for the regions 1 and 3 due to the overlap of window A, for the regions 2 and 4 due to the overlap of window B, for the regions 3 and 5 due to the overlap of window C, for the regions 4 and 6 due to the overlap of window D, and for the regions 5, 6, 7 and 8 due to the overlap of window E, respectively.

In this embodiment having eight screen regions, the same processing as that in the example with four monitors is also carried out. The applications 203 issue a depicting command for screen image display, and depicting module 204 depicts a screen image and stores it in frame buffer 205. The update detecting module 206 detects the update region, and screen image transfer module 207 generates the updated screen image.

Then, the screen image transfer module 207 checks with connection allotment module 208 for which connection corresponds to the display region where the updated screen image is located with, and sends the updated screen image to the communication module 201. For example, when the updated screen image is generated on the entirety of window E, transmission will be made using a connection with the transmission NICs defined as follows: the updated image of the region where the window E and a screen region 5 overlap is taken as the NIC 1, the updated image of the region where the window E and the screen region 6 overlap is taken as the NIC 2, the updated image of the region where the window E and a screen region 7 overlap is taken as the NIC 3, and the updated image of the region where the window E and a screen region 8 overlap is taken as the NIC 4.

The connection allotment module 208 sets the transmission NIC for each display region. For example, it may determine that transmission is carried out for the updated screen image with respect to screen regions 1 and 5 from the NIC 1, for the updated screen image with respect to the screen regions 2 and 6 from the NIC 2, for the updated search image with respect to the screen regions 3 and 7 from the NIC 3, and for the updated screen image with respect to the screen regions 4 and 8 from the NIC 4.

Under the instruction of the connection allotment module 208, the communication module 201 sets multiple connections with the display device 300. Then, the updated screen image generated by the screen image transfer module 207 is transmitted to the display device 300 by the assigned connections.

In this way, according to the first embodiment, the updated screen images of adjacent screen regions with a high probability of simultaneous updating are transmitted by different NICs, so that it is possible to decrease the drift in the arrival time to the display device 300, and it is possible to make the drift in the display timing insignificant to a user.

### Second Embodiment

In the first embodiment, the updated screen images of the adjacent screen regions are transmitted by the connections using different transmission NICs. In the second embodiment, explanation will be made for the case when updated screen images generated simultaneously in the same application 203 are transmitted using connections such that the arrival times of the updated screen images at the display device 300 are the same or nearly so.

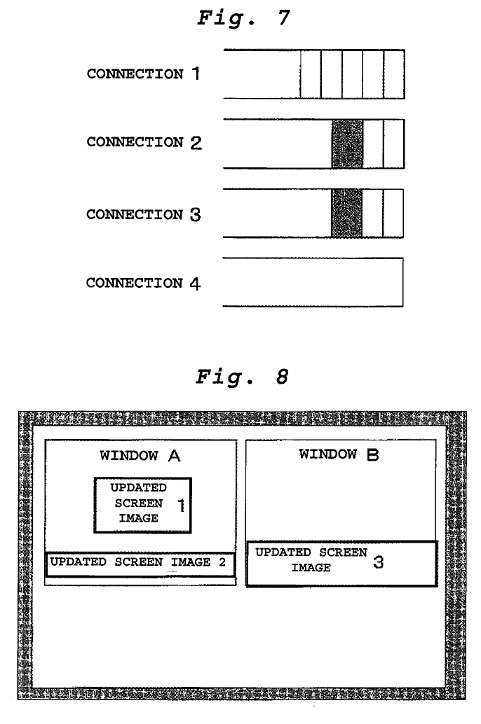

FIG. 6 is a block diagram illustrating the screen image transfer device 200 according to the second embodiment. FIG. 6 shows the embodiment of a screen image transfer device 200 having one NIC, and the display device 300 having four monitors. Here, the number of the NICs of the communication module 201 is not limited to one, and the number of the monitors of the display device 300 is not limited to four, a greater or lesser number of monitors may be used.

In the second embodiment, the functions of the layout storage module 202, the connection allotment module 208, and the screen image transfer module 207 are somewhat different from those in the first embodiment. Additionally, the second embodiment includes a connection information acquisition module (as depicted in FIG. 6). The other component features are the same as those of the screen image transfer device 200 according to the first embodiment. Consequently, they will not be explained in detail again.

In the second embodiment, in addition to the display region, the layout storage module 202 also stores information about the layout of the screen image displayed on the display device 300. The layout information is stored using coordinate information or other positional information. There is no specific restriction on the storage method, and any method may be adopted as long as the configuration of the screen image layout information can be understood.

In the embodiment shown in FIG. 6, the layout information is displayed on a screen image having width of 2800 pixels and a height of 2100 pixels with the following windows: window A displayed at the position of (900, 10) on the screen image and with a width of 1024 pixels and a height of 768 pixels, and window B displayed at the position of (120, 1100) on the screen image and with a width of 1024 pixels and a height of 768 pixels. Windows may overlap each other; in this case, the overlap information indicating display of one window (e.g., window C) on another window (e.g., window D) may simply be added to the layout information. One may also add clip information, such as the information indicating clipping (cut off of a portion of a window without display) of some portion of a window or windows.

The connection information acquisition module depicted in FIG. 6 acquires the information concerning the various connections. For example, it may acquire the following types of information: the transmission queue length indicating how long before the data may be sent, the window size indicating the data quantity that can be transmitted in a single round of operation, the hop number between device 200 and the display device 300, time required for a single packet to travel from device 200 to the display device 300, the send buffer size indicating the data quantity that can be stored to be transmitted, etc.

On the basis of the information acquired by the connection information acquisition module, the connection allotment module 208 selects connections for the updated screen images to be displayed at the same time so that their arrival times to the display device 300 are the same or nearly so. When there is no need to align the display timing, the connection with the shortest transmission queue length, the largest window size, the smallest hop number, the shortest time, and the largest send buffer size may be selected as appropriate.

FIG. 7 shows an example of allotment of connections made in consideration of the length of the transmission queue. As shown in the example of FIG. 7, data of 5120 bytes resides in the connection 1 queue, data of 2048 bytes resides in the queue of connections 2 and 3, and the connection 4 queue is empty. When there are two updated screen images that should be displayed simultaneously, the connections 2 and 3 with the same transmission queue length would be selected. When there are three updated screen images to be displayed simultaneously, the connections 2, 3 and 4 would be selected. When there are five updated screen images to be displayed simultaneously, two updated screen images would be allotted to the connection 4, and the remaining updated screen images are allotted one by one to the connections 1 through 3.

For updated screen images generated simultaneously, the screen image transfer module 207 checks the layout information of the display device stored in layout storage device 202. If the updated screen images are generated by the same application 203, they are taken as updated screen images that should be displayed simultaneously, and the connection that should be used in the connection allotment module 208 is set accordingly.

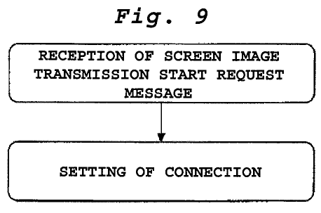

FIG. 8 is a diagram illustrating an example of the updated screen images. In FIG. 8, the three updated screen images were generated simultaneously, and among those three images, the updated screen images 1 and 2 that are to be generated in window A are taken as images which should be displayed simultaneously.

In the following, the screen image transfer processing by the screen image transfer device 200 according to the second embodiment will be explained.

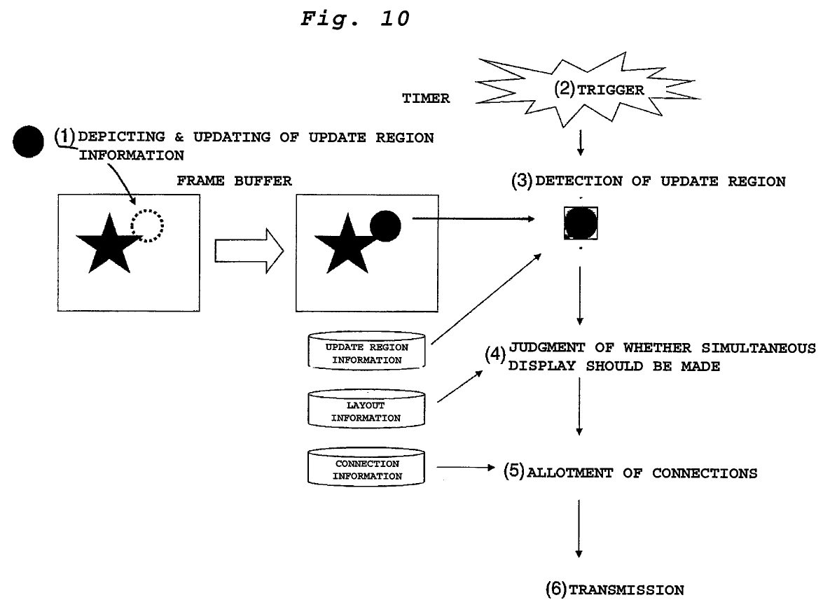

First, a brief account will be given on the initial screen image transfer processing with reference to FIG. 9. The function of setting the connection in the second embodiment is different from that in the first embodiment. The other functions are the same as those of the screen image transfer device 200 according to the first embodiment, and they will not be explained in detail again.

According to the first embodiment, the connection allotment module 208 sets the transmission NIC and connection for each screen region. But in the second embodiment, the communication module 201 sets any number of possible connections. For example, four connections that take the NIC 1 as the transmission NIC may be set.

In the following, the screen image transfer processing will be explained with reference to FIG. 10. Where the function of the screen image transfer device 200 is the same as that according to the first embodiment, it will not be explained in detail again.

According to the second embodiment, the screen image transfer module 207 checks the layout information, and it determines whether the updated screen images generated simultaneously by the same application 203 should be displayed simultaneously.

Then, the connection allotment module 208 checks the connection information (supplied by the connection information acquisition module), and it allots the connection with a high probability of simultaneous arrival to updated screen images that should be displayed simultaneously. For the updated screen images without such a requirement, the connection with a high probability of the first (quickest) arrival is allotted.

In this way, for the screen image transfer device 200 according to the second embodiment, the updated screen images generated simultaneously by the same application 203, and thus which are prone to recognition of the drift by the user if they are updated at different times are transmitted using the connections to the display device 300 with the same (or nearly the same) arrival time, so that the drift in the display timing can be made insignificant to the user.

While certain embodiments have been described, these embodiments have been presented by way of example only, and are not intended to limit the scope of the inventions. Indeed, the novel aspects described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A screen image transfer device for transmitting screen image data to a display device with a plurality of screen image regions, the screen image transfer device comprising:
a communication module configured to transmit the screen image data to the plurality of screen image regions over connection paths;
a connection allotment module configured to assign from a plurality of connection paths to the display device, the connection paths for transmitting the screen image data.

2. The screen image transfer device of claim 1, wherein the communication module includes a plurality of network interface cards, each network interface card configured to provide at least one of the connection paths to the plurality of screen image regions.

3. The screen image transfer device of claim 2, wherein
the screen image data is comprised of a first screen image data and a second screen image data, the first screen image data to be transmitted to a first screen region of the plurality of screen regions, and the second screen image data to be transmitted to a second screen region of the plurality of screen regions that is adjacent to the first screen region, and
the connection allotment module is configured to assign a first of the connection paths as the connection path for transmitting the first screen image data, and a second of the connection paths as the connection path for transmitting the second screen image data.

4. The screen image transfer device of claim 1, further comprising a connection information acquisition module configured to acquire connection information about the plurality of connection paths to the display device.

5. The screen image transfer device of claim 4, wherein the connection allotment module is configured to assign the connection paths for transmitting the screen image data to the screen image regions based on the connection information acquired by the connection information acquisition module.

6. The screen image transfer device of claim 5, wherein the connection information acquired by the connection information acquisition module includes at least one of a transmission queue length, a data quantity that can be transmitted in a single round of operation, a number of hops, time required for a single packet to be transmitted, and a send buffer size.

7. The screen image transfer device of claim 5, wherein
the screen image data is comprised of a first screen image data and a second screen image data, the first screen image data to be transmitted to a first screen region, and the second screen image data to be transmitted to a second screen region adjacent to the first screen region, and
the connection allotment module assigns a first of the connection paths as the connection path for transmitting the first screen image data and a second of the connection paths as the connection path for transmitting the second screen image data, such that the first screen image data is received by the first screen region at substantially the same time as the second screen image data is received by the second screen region.

8. The screen image transfer device of claim 7, wherein the first connection path and the second connection path are configured by one network interface card.

9. The screen image transfer device of claim 1, wherein the display device is comprised of a plurality of monitors.

10. The screen image transfer device of claim 9, wherein each monitor of the plurality of monitors comprises a separate screen image region.

11. The screen image transfer device of claim 10, wherein the connection allotment module assigns a different connection path to each monitor.

12. The screen image transfer device of claim 1, further comprising:
a frame buffer configured to store the screen image data to be transmitted to the display device;
a depicting module configured to generate the screen image data according to an application and to store the generated screen image data in the frame buffer;
an update detecting module configured to determine which of the plurality of screen image regions will be updated based on the screen image data generated by the depicting module; and
a screen image transfer module configured to transfer the screen image data to the communication module.

13. The screen image transfer device of claim 12, wherein the update detecting module performs a differential extraction to determine a difference between a current screen image data and a prior screen image data.

14. A screen image transfer system, comprising:
a display device including a plurality of screen regions for displaying an image;
a screen image transfer device configured to transmit screen image data to the display device over a plurality of network connections, wherein
the screen image data is comprised of a first screen image data and a second screen image data, the first screen image data to be transmitted to a first screen region of the plurality of screen regions, and the second screen image data to be transmitted to a second screen region of the plurality of screen regions that is adjacent to the first screen region, and
the screen image transfer device assigns a first network connection from the plurality of network connections for transmission of the first screen image data and a second network connection from the plurality of network connection for transmission of the second screen image data, such that the first screen data is received by the first screen region at substantially the same time as the second screen image data is received by the second screen region.

15. The screen image transfer system of claim 14, wherein the display device comprises a plurality of monitors.

16. The screen image transfer system of claim 14, wherein the screen image transfer devices comprises:
a communication module configured to transmit the screen image data to the plurality of screen image regions over the plurality of network connections;
a connection allotment module configured to assign network connections for transmitting the screen image data.

17. The screen image transfer system of claim 16, wherein the communication module comprises a plurality of network interface cards.

18. The screen image transfer system of claim 16, wherein the screen image transfer device further comprises:
a connection information acquisition module configured to acquire connection information about the plurality of network connection paths for transmitting the screen image data, and
the connection allotment module is configured to assign the network connections for transmitting the screen image data based on the connection information acquired by the connection information acquisition module.

19. A method for operating a screen image transfer system, comprising:
generating a first screen image data for display on a display device having a plurality of screen image regions;
transmitting the first screen image data to the display device;
generating a second screen image data for display on the display device;
comparing the first screen image data to the second screen image data to determine which of the plurality of screen image regions will be updated by the second screen image data;
establishing a plurality of connections for transmitting the second screen image data to the display device;
assigning the connections for transmitting the second screen image data such that screen image regions which are adjacent to each another will be updated by the second screen image data at substantially the same time.

20. The method of claim 19, further comprising:
acquiring connection information about the connections for transmitting the second screen image data.
